(19) United States
(12) Patent Application Publication
(10) Pub. No.: US 2026/0320390 A1
(43) Pub. Date: Oct. 15, 2026

(54) NEURAL NETWORKS WITH INTERMEDIATE BLOCK LOOPING

(71) Applicant: Google LLC, Mountain View, CA (US)

(72) Inventors: Nikunj Umesh Saunshi, Jersey City, NJ (US); Seyed Sobhan Mir Yoosefi, Brooklyn, NY (US)

(21) Appl. No.: 19/644,992

(22) Filed: Apr. 10, 2026

Related U.S. Application Data
(60) Provisional application No. 63/786,866, filed on Apr. 10, 2025.

(51) Int. Cl. G06N 3/08; G06N 3/045

(52) U.S. Cl. CPC G06N 3/08; G06N 3/045

(57) ABSTRACT

Methods, systems, and apparatus, including computer programs encoded on computer storage media, for performing a machine learning task on a network input to generate a network output using a neural network with intermediate block looping.

### CROSS-REFERENCE TO RELATED APPLICATIONS

This application claims priority to U.S. Provisional Application No 63/786,866, filed on Apr. 10, 2025. The disclosure of the prior application is considered part of and is incorporated by reference in its entirety in the disclosure of this application.

### BACKGROUND

This specification relates to neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a system implemented as computer programs on one or more data processing apparatuses in one or more locations that trains, implements, or both a neural network with intermediate block looping to perform one or more machine learning tasks on a network input.

The subject matter described in this specification can be implemented in particular embodiments so as to realize one or more of the following advantages.

By iteratively looping over each of one or more intermediate blocks in a sequence of blocks in the neural network, i.e., repeatedly feeding an output of an intermediate block as input to the intermediate block, during each forward pass through the sequence of blocks, the neural network recursively reuses the parameters of the one or more intermediate blocks across multiple looping iterations when performing inference. In this way, the intermediate block looping technique increases the effective depth of the neural network.

For example, a Transformer-based neural network with 1 billion parameters that implements the described intermediate block looping technique can outperform, e.g., achieve up to 13.5 percent improvement in few-shot accuracy relative to, a non-looped baseline neural network that has a comparable parameter count, and can perform on par with, e.g., have no noticeable perplexity drop relative to, a larger, non-looped baseline neural network with twice as many parameters.

The neural network implementing the described intermediate block looping technique enables more efficient use of computational resources (in particular, memory resources) of an inference system than non-looped neural networks while having comparable model performance. Since the effective depth is increased by virtue of reusing existing parameters and as such, no additional parameters need to be learned and stored, the neural network has a smaller memory footprint, and thereby occupying less space in a logical data storage area or physical data storage device, relative to a non-looped neural network that has a comparable depth.

The described intermediate block looping techniques thus increase the effective depth and therefore the performance of a neural network without adding a large number of additional parameters, and therefore without significantly increasing the memory footprint of the neural network, i.e., the amount of memory required to store or deploy the neural network.

Therefore the intermediate block looping technique presents an effective solution to address the technical challenges faced when deploying large neural networks in resource-constrained environments, e.g., deploying a large language model neural network on mobile devices, or on lower-grade data processing apparatuses where memory resources are limited. In some implementations, the number of looping iterations can be tailored to the particular memory constraints of the particular data processing apparatuses on which the neural network is deployed, thereby optimizing the neural network for particular hardware.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for performing a machine learning task using a neural network.

FIG. 3 is a flow diagram of sub-steps of one of the steps of the process of FIG. 2.

FIG. 4 is an illustration of a neural network with intermediate block looping in comparison to baseline neural networks.

FIG. 5 shows accuracy improvements of a neural network with intermediate block looping compared to baseline neural networks.

Like reference numbers and designations in the various drawings indicate like elements.

### DETAILED DESCRIPTION

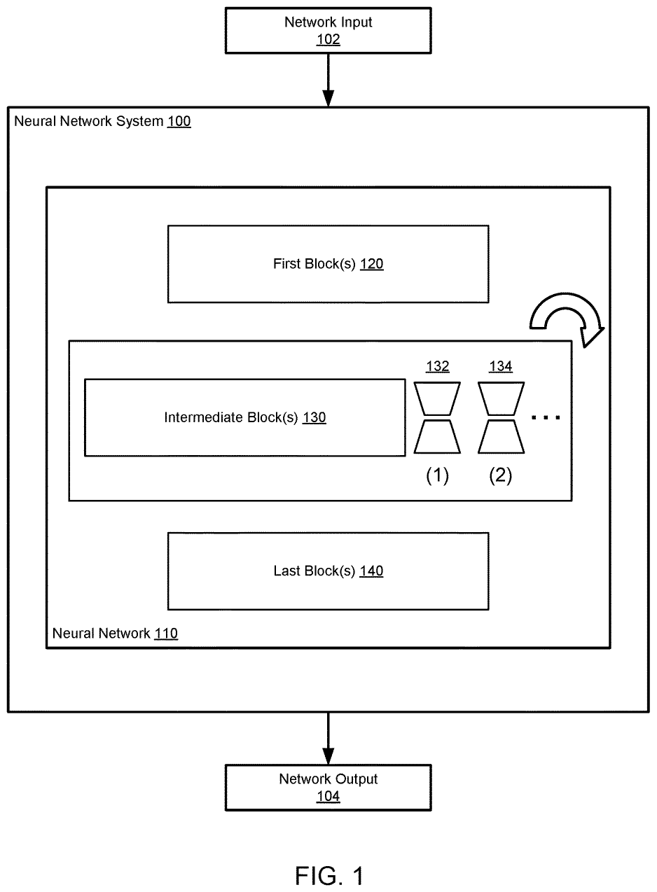

FIG. 1 shows an example neural network system 100. The neural network system 100 is an example of a system implemented as computer programs on one or more data processing apparatuses in one or more locations that implements a neural network 110 to perform one or more machine learning tasks on a network input 102 to generate a network output 104.

The machine learning tasks can include any machine learning task that (i) operates on a network input that is an input sequence, (ii) generates a network output that is an output sequence, or (iii) both. In some cases, the input sequence can represent a conditioning input that provides context for the network output, e.g., the output sequence.

Some examples of machine learning tasks that the system can be configured to perform are discussed below.

As one example, the task may be a neural machine translation task. For example, if the network input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

As another example, the task may be an audio processing task. For example, if the network input to the neural network is a sequence representing a spoken utterance, the network output generated by the neural network may be a score for each of a set of pieces of text, each score representing an estimated likelihood that the piece of text is the correct transcript for the utterance. As another example, if the network input to the neural network is a sequence representing a spoken utterance, the network output generated by the neural network can indicate whether a particular word or phrase (“hotword”) was spoken in the utterance. As another example, if the network input to the neural network is a sequence representing a spoken utterance, the network output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the network input is text in a natural language or features of text in a natural language and the network output is a spectrogram, a waveform, or other data defining audio of the text being spoken in the natural language.

As another example, the task can be a health prediction task, where the network input is a sequence derived from electronic health record data for a patient and the network output is a prediction that is relevant to the future health of the patient, e.g., a predicted treatment that should be prescribed to the patient, the likelihood that an adverse health event will occur to the patient, or a predicted diagnosis for the patient.

As another example, the task can be a text generation task, where the network input is a sequence of text, and the network output is another sequence of text, e.g., a completion of the input sequence of text, a response to a question posed in the input sequence, or a sequence of text that is about a topic specified by the first sequence of text. In this example, both the input sequence of text and the output sequence of text can include tokens from a vocabulary of text tokens that includes, e.g., one or more of characters, sub-words, words, punctuation marks, numbers, or other symbols that appear in a natural language or a computer language.

As a similar example, the task can be an automatic code generation task, where the network input is a sequence of words, wordpieces or characters in a first natural language and the network output is a sequence of tokens that represent instructions in a computer programming or markup language, or instructions for controlling an application program to perform a task e.g. build a data item such as an image or web page.

As a particular example of this, the network input can represent a context input that includes a text description of a desired piece of code or a snippet of computer code in a programming language and the network output can be an output sequence that includes computer code, e.g., a snippet of code that is described by the context input or a snippet of code that follows the context input in a computer program.

As another example, the network input to the text generation task can be an input other than text, e.g., an image or audio, and the output sequence can be text that describes the input. In this example, both the input sequence of text and the output sequence of text can include tokens from a vocabulary of tokens that includes tokens that can represent data other than text, in addition to the text tokens mentioned above.

For example, the vocabulary of tokens can additionally include image tokens that represent a discrete set of image patch embeddings of an image that can be generated by an image encoder neural network based on processing the image patches of the image. As another example, the vocabulary of tokens can additionally include audio tokens that represent code vectors in a codebook of a quantizer, e.g., a residual vector quantizer.

As another example, the task can be an image generation task, where the network input is a conditioning input, e.g., text, a lower-resolution image, or a partial image, and the network output is a sequence of intensity value inputs for the pixels of an image.

As another example, the task can be an image processing task. For example, the network input can be the intensity values of the pixels of the image or an encoded representation of the intensity values of the pixels generated by an encoder neural network, and the network output can be (i) an image classification output that classifies the input image into one of a plurality of object categories (ii) an object detection output, i.e., a sequence that specifies the coordinates of one or more bounding boxes in the image that are predicted to encompass objects or (iii) a segmentation output that classifies each pixel in the input image into one of a plurality of categories. As another example, the network input can include the intensity values of the pixels of the image or an encoded representation of the intensity values of the pixels generated by an encoder neural network and optionally text, and the network output can be text that characterizes the image, e.g., captions the image or answers a question posed by the text in the input about the image.

As another example, the task can be an audio generation task, where the network input is a conditioning input, e.g., text, an image, or context audio, and the network output is a sequence of tokens that represents audio.

As another example, the task can be an audio processing task. For example, the network input can include audio or an encoded representation of the audio generated by an encoder neural network, and the network output can be text or an image that characterizes the audio.

As another example, the task can be an agent control task, where the network input is a sequence of observations or other data characterizing states of an environment and the network output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the network input is a sequence representing a fragment of a DNA sequence or other molecule sequence and the network output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the neural network is configured to perform multiple different individual machine learning tasks, e.g., two or more of the machine learning tasks mentioned above. For example, the neural network can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example detection or classification of an object or event may be improved when data of multiple different types (modalities) is processed. As another example, the quality (e.g., accuracy, fidelity, or intelligibility) of a generated image, video, or audio may be improved when data of multiple different types (modalities) is processed.

In some cases, once trained, the neural network can perform tasks that it was not explicitly trained to perform. For example the neural network can perform translation tasks (provided that the training corpus included words in different languages), generative tasks, and many other tasks.

In these cases, the neural network can be made to perform a particular task by providing a natural language description of the desired response as a part of the input or “prompt”. The prompt may be a few-shot prompt where a few, e.g., 1 to 10, examples of a query and an example output are provided in the text prior to the actual query.

Additional description of generative tasks that the neural network 110 (when configured as a “generative” neural network) can perform are discussed below.

Generally, the generative neural network is configured to process a conditioning input (“prompt”) to generate a data item. The data item can include data in any of a variety of modalities, e.g., text data, image data, video data, or audio data. Generally, the data item represents a response to the conditioning input which may be, e.g. a “prompt” for the generative neural network. For example, the conditioning input can characterize one or more desired properties for the generated data item.

In some implementations the generative neural network generates an output token sequence from an input token sequence including the conditioning input. The generative neural network may then be configured to process the input token sequence to generate for each position in the output token sequence, a respective score for each token in a vocabulary of output tokens, that is used to select an output token for the output token sequence.

In some implementations the tokens can represent text, e.g., words, wordpieces or characters, in a natural or computer language. For example, text may be received, e.g., as a series of encoded characters, e.g. UTF-8 encoded characters; such “characters” can include Chinese and other similar characters, as well as logograms, syllabograms and the like. A text encoder, i.e. a tokenizer, can process a sequence of text to represent the text as a series of text tokens from a vocabulary of text tokens, e.g. that each represent words, wordpieces or characters in a natural or computer language. The computer language may be any formal language used to communicate with a computer, e.g. a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens may be converted into audio data that represent speech corresponding to the text.

Also, or instead the tokens may represent an image. For example, a set (sequence) of input or output tokens can represent an image. Each image token may comprise a block encoding of values of the pixels in a different region of an image that maps a set of values of the pixels to a respective image token. The block encoder may comprise a neural network, e.g. having one or more (self-)attention layers, such as a Transformer neural network.

Also, or instead the tokens may represent an audio waveform. For example, a set (sequence) of input or output tokens can represent audio data representing a waveform e.g. instantaneous audio amplitude values or time-frequency audio data. Each image token may comprise a block encoding of the audio waveform in a different time segment of the audio that maps a set of values representing the audio waveform to a respective image token. The block encoder may comprise a neural network, e.g. having one or more (self-)attention layers, such as a Transformer neural network.

In a multimodal system audio data or an image may be flagged by a start-of-audio token or start-of-image token.

In some implementations the generative neural network can be a multimodal network that is configured to process a conditioning input comprising one or more of text data, audio data defining an audio signal (e.g. as amplitude values of the audio signal or as a time-frequency representation of the audio signal), or a still or moving image (e.g. as image pixel values), to generate a data item that can similarly comprise text data, audio data, or a still or moving image.

For example, the conditioning input may comprise text and the data item may comprise an image or an audio signal that represents speech an image generated in response to the text, e.g. described by the text. Also, or instead the conditioning input may comprise an audio signal that represents speech, or an image, and the data item may comprise text, e.g. that describes the conditioning input.

As another example the conditioning input may comprise an observation, e.g. of a real world environment, e.g. from sensor such as a camera or other image sensor; and optionally additional information such as information defining a particular task to be deformed. The output data item may comprise agent control data that defines one or more actions to be performed by an agent, e.g. by a mechanical agent such as a robot or autonomous vehicle, to perform a task. The reward model(s) may, e.g., define a preferred trajectory of motion of the mechanical agent in the (real-world) environment.

In some implementations, the input sequence, the output sequence, or both represents: computer code, text , image, video, audio, a point cloud, one or more biometrics, a three-dimensional (3D) mesh of a real-world environment and/or one or more objects in the real-world environment, one or more physiological measurements of an individual or animal, telemetry of machinery, meteorological information about a real-world environment, one or more genomic sequences, a chemical structure, or a molecular structure. That is, the input and/or output sequence may represent any number of suitable modalities.

The machine learning task described herein may be a task in a real-world environment. For example, the task in the real-world environment may include operating a robotic device in the real-world environment based upon the network input.

The machine learning task described herein may comprise one or more of: an image generation task, an image reconstruction task, an image modification task, an image captioning task, an image classification task, and a video frame prediction task; a simulation task of simulating a real-world environment depicted by an image, in particular wherein the machine learning model for performing the simulation task is configured to predict one or more states of the real-world environment based upon the image; a visual question-answering (VQA) task including providing an answer to a question based upon an image; an agent control task including selecting one or more actions for one or more agents operating within a real-world environment and causing the one or more selected actions to be performed by the one or more agents in the real-world environment; an object detection task including detecting one or more objects depicted in an image; an action detection task including detecting one or more actions depicted in an image; a first automatic computer code generation task including generating computer code that, when executed, causes one or more computers to be controlled in accordance with the computer code, wherein the computer code is generated based upon a query comprising an image indicating instructions defining functionality and/or constraints for the computer code to be generated; a second automatic computer code generation task including generating computer code that, when executed by one or more computers, (a) does not include one or more compile or runtime errors, (b) does not include one or more privacy or security vulnerabilities, and/or (c) does not cause the one or more computers to undergo memory leakage; an optical character recognition task including recognizing one or more characters or words depicted in an image; an image-based retrieval task including retrieving one or more output images from an image database; a computer security monitoring task including monitoring security of one or more computers based upon an image; a biometric recognition task including recognizing one or more biometrics of an individual or animal; a real-world classification task including classifying a real-world environment and/or one or more objects in the real-world environment; a physiological classification task including classifying one or more physiological measurements of an individual or animal; a machine telemetry monitoring or classification task including monitoring or classifying telemetry of machinery; a meteorological monitoring or classification task including monitoring or classifying meteorological information about a real-world environment; a genomic classification task including classifying one or more genomic sequences; a chemical structure classification or prediction task including either classifying a chemical structure of a chemical or predicting a chemical structure of a chemical; and a molecular structure classification or prediction task including either classifying a molecular structure of a molecule or predicting a molecular structure of a molecule.

In a specific example, the image generation task includes generating a photorealistic landscape of a futuristic city based on an input indicating “neon-lit skyscrapers in the rain in a real-world environment”.

In a specific example, the image reconstruction task includes restoring a damaged or pixelated image by in-painting missing details and/or sharpening edges.

In a specific example, the image modification task includes altering an image of a living room in a real-world environment to replace the existing furniture with a modern sofa and coffee table. In a specific example, the image captioning task includes generating a descriptive sentence “A golden retriever catching a frisbee in a grassy park” as a caption for a photo of that scene.

In a specific example, the image classification task includes analyzing a medical X-ray image to classify the image into a healthy or unhealthy class.

In a specific example, the video frame prediction task includes predicting frames of a video representing a car driving down a street in a real-world environment to anticipate a future position of the vehicle and surrounding traffic movement.

In a specific example, the simulation task includes simulating the flow of floodwaters through a simulation of a real-world urban environment based on an aerial image of the current terrain and water levels.

In a specific example, the visual question-answering (VQA) task includes processing an image of an interior of a refrigerator to answer a query from a user indicating “do I have enough eggs to bake a cake?”.

In a specific example, the agent control task includes controlling a robotic arm in a warehouse to identify, grasp, and/or sort packages onto a conveyor belt based on real-time visual input from the real-world environment in which the robotic arm is based.

In a specific example, the object detection task includes identifying pedestrians, vehicles, and/or traffic present in a real-world environment based upon image(s) fed from a camera feed of an autonomous vehicle.

In a specific example, the action detection task includes analyzing security footage to flag a specific segment of the footage where an individual is depicted in a real-world environment climbing over a restricted fence.

In a specific example, the first automatic computer code generation task includes generating valid HTML, CSS, and JavaScript code to render a website layout that matches a hand-drawn wireframe sketched on a whiteboard in a real-world environment.

In a specific example, the second automatic computer code generation task includes generating a Python script for processing data that is verified to be free of SQL injection vulnerabilities and memory leaks before execution.

In a specific example, the optical character recognition task includes recognizing a restaurant receipt in an image and digitizing the text to extract the line items and total cost into a spreadsheet.

In a specific example, the image-based retrieval task includes retrieving similar products available for purchase from an online database based upon an upload a photo of a specific pair of trainers provided by a user.

In a specific example, the computer security monitoring task includes monitoring visual logs or screenshots of a desktop session on a computer to detect anomalous behavior indicative of a remote desktop hijack or unauthorized access.

In a specific example, the biometric recognition task includes recognizing an iris of a user based upon an image to authenticate their identity and grant access to a secure facility.

In a specific example, the real-world classification task includes analyzing satellite imagery to categorize different land areas as “forest,” “urban,” “agricultural,” or “water body.”.

In a specific example, the physiological classification task includes classifying a current state of a user as “resting,” “exercising,” or “stressed” based on skin tone changes and movement.

In a specific example, the machine telemetry monitoring or classification task includes analyzing thermal telemetry data of a jet engine to detect overheating components that indicate a need for maintenance.

In a specific example, the meteorological monitoring or classification task includes monitoring cloud patterns in satellite images to classify a developing storm system as a potential hurricane.

In a specific example, the genomic classification task includes processing a visual representation of a Deoxyribonucleic acid (DNA) sequence to classify it as containing a specific genetic marker associated with a characteristic of a food crop.

In a specific example, the chemical structure classification or prediction task includes predicting a three-dimensional (3D) structure of a new drug compound based on its two-dimensional (2D) molecular diagram to estimate its binding affinity.

In a specific example, the molecular structure classification or prediction task includes classifying the folded structure of a protein molecule into a specific family based on an image generated thereof.

In general, the neural network 110 can have any appropriate architecture to enable it to perform these machine learning tasks, e.g., to perform a generative task by processing the conditioning input to generate the data item.

The neural network 110 includes a sequence (or stack) of blocks that include one or more first blocks 120, followed by one or more intermediate blocks 130, followed by one or more last blocks 140.

A block refers to a group of one or more contiguous neural network layers in a neural network. For example, the neural network 110 can include a plurality of neural network layers, and each block can include a different subset of the plurality of neural network layers.

Each block includes a respective set of parameters. The respective set of parameters includes parameters of each of the one or more contiguous neural network layers included in the block.

The sequence of blocks are at different depths along a depth dimension of the architecture of the neural network 110. An intermediate block 130 is at a greater depth than a first block 120. A last block 140 is at a greater depth than an intermediate block 130. Generally, blocks at greater depths are executed after blocks at smaller depths during each forward pass through the sequence of blocks.

When there are multiple intermediate blocks 130 (or, analogously, multiple first blocks 120 or multiple last blocks 140), they are at different depths. For example, a subsequent intermediate block that follows a preceding intermediate block is at a greater depth than the preceding intermediate block.

The plurality of neural network layers can include any kind of neural network layers, for example, attention layers, e.g., self-attention layers, multi-head self-attention layers, or cross-attention layers, convolutional layers, fully-connected layers, embedding layers, activation layers, or recurrent layers, e.g., Long Short-Term Memory (LSTM) layers or gated recurrent unit (GRU) layers.

An attention layer is a neural network layer that applies an attention mechanism. Generally, to apply the attention mechanism, the attention layer uses one or more attention heads. Each attention head generates a set of queries, a set of keys, and a set of values, and then applies any of a variety of variants of query-key-value (QKV) attention using the queries, keys, and values to generate an output. When there are multiple attention heads, the attention layer then combines the outputs of the multiple attention heads, e.g., by concatenating the outputs and, optionally, processing the concatenated outputs through a linear layer.

Examples of QKV attention variants are described in Vaswani, et al., attention Is All You Need, arXiv: 1706.03762, Raffel, et al, Exploring the Limits of Transfer Learning with a Unified Text-to-Text Transformer, arXiv: 1910.10683, Devlin et al., BERT: Pre-training of Deep Bidirectional Transformers for Language Understanding, arXiv: 1810.04805, Kitaev, et al., Reformer: The efficient transformer, arXiv preprint arXiv: 2001.04451, and Chowdhery, et al., Palm: Scaling language modeling with pathways. Journal of Machine Learning Research 24.240 (2023): 1-113, the entire contents of which are hereby incorporated by reference herein in their entirety.

In some implementations, the one or more intermediate blocks 130 each include a same number and type of layers. For example, each intermediate block 130 can be an attention block that includes one or more attention layers and, optionally, one or more other layers, e.g., a feed-forward layer, an activation layer, or a normalization layer.

The neural network 110 is configured to perform a machine learning task by performing one or more forward passes through the sequence of blocks—including the one or more first blocks 120, the one or more intermediate blocks 130, and the one or more last blocks 140—in the neural network.

In some cases, the neural network can receive a network input 102 and perform a single forward pass through the sequence of blocks using the network input to generate a network output 104 for the machine learning task. In these cases, the network input 102 is received by the first block 120 in the sequence of blocks, and the network output 104 is generated by the last block 140 in the sequence of blocks.

In some cases where the task is a generative task, the neural network 110 (when configured as an auto-regressive neural network) can execute an auto-regressive generation process across a plurality of generation steps to generate a data item that is an output sequence made up of tokens from a vocabulary, conditioned on a conditioning input (“prompt”) that provides context for the output sequence. In these cases, each generation step corresponds to a respective forward pass through the sequence of blocks.

More specifically, the auto-regressively generated output sequence is created by, at each generation step, generating a particular token in the output sequence conditioned on a current input sequence that includes any tokens that precede the particular token in the output sequence, i.e., the tokens that have already been generated for any previous positions in the output sequence that precede the particular position of the particular token, and the prompt.

For example, the current input sequence when generating a token at any given position in the output sequence can include the input sequence and the tokens at any preceding positions that precede the given position in the output sequence. As a particular example, the current input sequence can include the prompt followed by the tokens at any preceding positions that precede the given position in the output sequence.

More specifically, at each generation step, to generate a particular token at a particular position within an output sequence, the neural network 110 can process the current input sequence or a portion thereof (e.g., the most recently generated token) to generate a score distribution, e.g., a probability distribution, that assigns a respective score, e.g., a respective probability, to each token in the vocabulary of tokens. The neural network 110 can then select, as the particular token, a token from the vocabulary using the score distribution. For example, the neural network 110 can greedily select the highest-scoring token or can sample, e.g., using nucleus sampling or another sampling technique, a token from the distribution.

In these cases, at each generation step, the current input sequence is received by the first block 120 in the sequence of blocks, and the score distribution is generated by the last block 140 in the sequence of blocks after the neural network 110 has performed a forward pass through the sequence of blocks using the current input sequence.

In some cases where the task is a generative task, the neural network 110 (when configured as a diffusion neural network) can execute a reverse diffusion process across a plurality of updating iterations to generate a data item. In these cases, each updating iteration corresponds to a respective forward pass through the sequence of blocks.

At each updating iteration, the neural network 110 is configured to map a diffusion input that includes a current (noisy) representation of the data item and a conditioning input and to generate an updated representation of the data item. The diffusion input at each updating iteration can also include data defining a noise level for the updating iteration.

In some implementations, the neural network 110 performs a reverse diffusion process in output space, e.g., pixel space in the case of images. In this example, the representations operated on and generated by the neural network have values for each pixel that specify color values, e.g., RGB values or another color encoding scheme.

In some other implementations, the neural network 110 performs a reverse diffusion process in latent space, e.g., in a latent space that is lower-dimensional than the output space. That is, the representations operated on by the neural network are latent representations and the values in the representations are learned, latent values, e.g., rather than color values.

The updated representation of the data item can either be generated directly, e.g., where a denoising output of the neural network for the updating iteration includes the updated representation, or indirectly, e.g., where the denoising output includes a noise term computed by the neural network for the updating iteration, and the updated representation can then be generated by removing at least some of the noise from the current representation in accordance with the noise term. The noise term is an estimate of the noise, as computed by the neural network, that has been added to the data item to arrive at the current representation.

In these cases, at each updating iteration, the current representation is received by the first block 120 in the sequence of blocks, and the denoising output (from which the updated representation can be derived) is generated by the last block 140 in the sequence of blocks after the neural network 110 has performed a forward pass through the sequence of blocks using the current representation.

In any of these cases, during each forward pass, the neural network 110 applies a looping mechanism on the one or more intermediate blocks 130 to iteratively loop over each of the one or more intermediate blocks 130.

That is, the neural network 110 repeatedly, i.e., at each of multiple looping iterations, feeds an output of an intermediate block 130 as input to the same intermediate block 130 for processing to generate another output of the intermediate block 130 and, after the multiple looping iterations, feeds an output of the intermediate block 130 generated in the last looping iteration as input to a subsequent block in the sequence of blocks included in the neural network. For example, the subsequent block can be a last block, or a subsequent intermediate block that follows the intermediate block 130.

By repeatedly performing the multiple looping iterations, the intermediate block 130 generates, from an intermediate block input, a final intermediate block output. The intermediate block input is received by the intermediate block 130 from a preceding block in the sequence of blocks. For example, the preceding block can be a first block, or a preceding intermediate block that immediately precedes the intermediate block 130.

At any looping iteration before the last looping iteration, the intermediate block 130 generates a current intermediate block output, which will then be used as a current intermediate block input for the immediately subsequent looping iteration. At the last looping iteration, the intermediate block 130 generates a current intermediate block output, which will then be used as the final intermediate block output.

In particular, during each forward pass through the sequence of blocks, the intermediate block 130 receives an intermediate block input from a preceding block in the sequence, performs multiple looping iterations, and, after having performed the multiple looping iterations, provides a final intermediate block output to a subsequent block in the sequence.

Thus, in some implementations, the intermediate block 130 is not a block that receives the network input (or, analogously, the current input sequence or the diffusion input), or generates the network output (or, analogously, the score distribution or the denoising input).

In some implementations, each intermediate block 130 includes one or more sets of adaptation parameters. The one or more sets of adaptation parameters are separate from, and can be used together with, the parameters of each of the one or more contiguous neural network layers included in the intermediate block 130.

In these implementations, at any looping iteration, the intermediate block 130 can process a current intermediate block input in accordance with (i) the parameters of each of the one or more contiguous neural network layers included in the intermediate block 130 and (ii) a set of adaptation parameters to generate a current intermediate block output.

For example, a set of adaptation parameters of the intermediate block 130 can include a respective set of adaptation parameters for each of one or more layers, e.g., one or more attention layers, in the intermediate block 130.

While the parameters of each of the one or more contiguous neural network layers included in the intermediate block 130 can have values that are learned during the pre-training stage of the neural network 110, the respective set of adaptation parameters for each of the one or more layers can have values that are learned during the fine-tuning stage of the neural network 110. Thus, the parameters of each of the one or more contiguous neural network layers included in the intermediate block 130 are learned independently from the respective set of adaptation parameters for each of the one or more layers.

In some of these implementations, each intermediate block 130 includes a respective set of adaptation parameters corresponding to each looping iteration in the multiple looping iterations; each set of adaptation parameters is used only at the corresponding looping iteration, and not in any other looping iterations. The multiple sets of adaptation parameters can have distinct values.

For example, FIG. 1 illustrates that the intermediate block 130 includes a first set of adaptation parameters 132 corresponding to a first looping iteration and a second set of adaptation parameters 134 corresponding to a second looping iteration.

At the first looping iteration, the intermediate block 130 can process a current intermediate block input corresponding to the first looping iteration in accordance with (i) the parameters of each of the one or more contiguous neural network layers included in the intermediate block 130 and (ii) the first set of adaptation parameters 132 corresponding to the first looping iteration to generate a current intermediate block output corresponding to the first looping iteration.

At the second looping iteration, the intermediate block 130 can process a current intermediate block input corresponding to the second looping iteration (the current intermediate block output corresponding to the first looping iteration) in accordance with (i) the parameters of each of the one or more contiguous neural network layers included in the intermediate block 130 and (ii) the second set of adaptation parameters 134 corresponding to the second looping iteration to generate a current intermediate block output corresponding to the second looping iteration.

In some of these implementations, the one or more sets of adaptation parameters include one or more sets of low-rank approximation (LoRA) parameters, i.e., one or more sets of parameters learned using a low-rank approximation (LoRA) technique (as described in Edward Hu, et al. “Lora: Low-rank adaptation of large language models.” arXiv preprint arXiv: 2106.09685 (2021)), or another rank-decomposition-based approximation technique.

Low-rank approximation refers to breaking up a matrix containing the adaptation parameters to be learned into a product of two smaller matrices that when multiplied together can (approximately) recover the adaptation parameters.

Unlike these intermediate blocks 130, the neural network 110 does not apply the looping mechanism on any of the one or more first blocks 120, or the one or more last blocks 140.

For example, suppose that there is just one first block; during each forward pass, the output of the first block will be directly fed as input to an intermediate block (rather than being fed back as input to the first block). That is, the neural network 110 does not loop over the first block.

As another example, suppose that there includes two first blocks: an initial first block followed by a subsequent first block; during each forward pass, the output of the initial first block will be directly fed as input to the subsequent first block (rather than being fed back as input to the initial first block), and the output of the subsequent first block will be directly fed as input to an intermediate block (rather than being fed back as input to the subsequent first block).

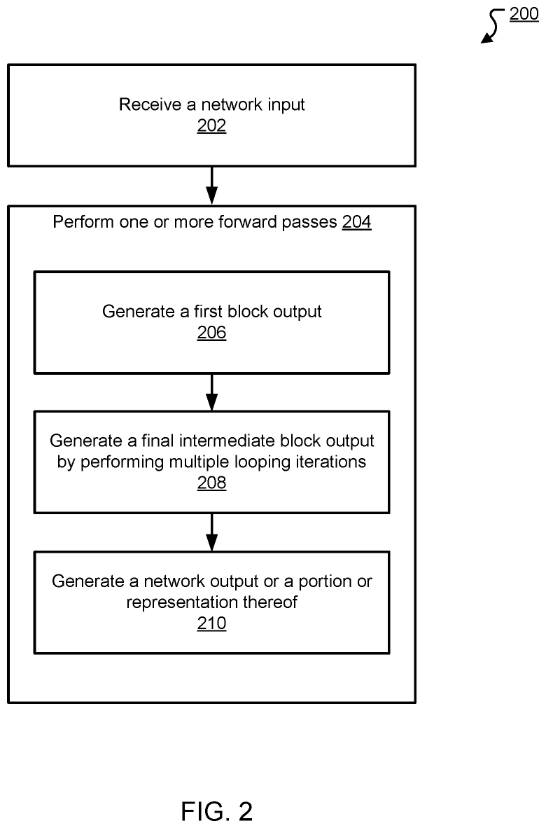

FIG. 2 is a flow diagram of an example process 200 for performing a machine learning task using a neural network. The neural network includes a sequence of blocks that include one or more first blocks, followed by one or more intermediate blocks, followed by one or more last blocks.

For convenience, the process 200 will be described as being performed by a system of one or more data processing apparatuses located in one or more locations. For example, a neural network system, e.g., the neural network system 100 of FIG. 1, appropriately programmed in accordance with this specification, can perform the process 200.

The system receives a network input for a machine learning task (step 202).

The system performs one or more forward passes through the sequence of blocks based on the network input to generate a network output for the machine learning task (step 204). During each forward pass, the neural network applies a looping mechanism on the one or more intermediate blocks to iteratively loop over each of the one or more intermediate blocks.

Steps 206-210 are performed during each forward pass.

The system processes the network input, data derived from the network input, or both using the one or more first blocks to generate a first block output (step 206).

For example, the data derived from the network input can include a current input sequence corresponding to a generation step in an auto-regressive generation process, or a portion thereof, e.g., the most recently generated token.

As another example, the data derived from the network input can include a current representation of a data item corresponding to an updating iteration in a reverse diffusion process.

In particular, the system performs, using the network input or data derived from the network input or both, a single forward pass through the one or more first blocks to generate the first block output without performing any looping iterations over any of the one or more first blocks.

For each of the one or more intermediate blocks, the system processes an intermediate block input to generate a final intermediate block output by performing multiple looping iterations until a loop termination criterion is satisfied (step 208), e.g., until a threshold number of looping iterations or until a threshold amount of wall clock time has elapsed.

The intermediate block input obtained for a first intermediate block is the first block output generated by a last first block in the one or more first blocks from processing the network input or data derived from the network input or both. The intermediate block input obtained for each subsequent intermediate block is the final intermediate block output generated by an immediately preceding intermediate block.

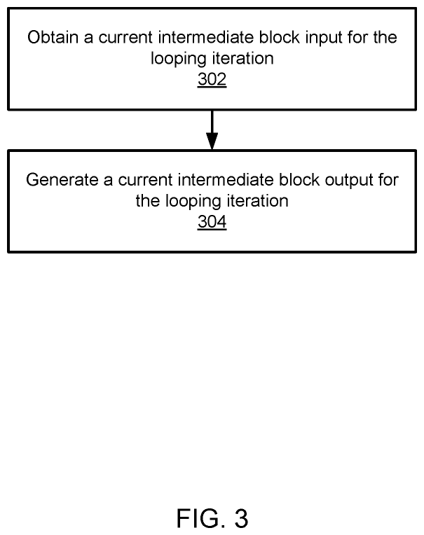

Step 208 is explained in more detail with reference to FIG. 3, which shows sub-steps 302-304 corresponding to step 208. An iteration of steps 302-304 corresponds to a looping iteration. The system can repeatedly perform multiple iterations of steps 302-304 for each intermediate block.

The system obtains a current intermediate block input for the looping iteration (step 302).

The current intermediate block input for a first looping iteration is the intermediate block input. The current intermediate block input for each subsequent looping iteration is a current intermediate block output generated by the intermediate block for a preceding looping iteration.

The system processes the current intermediate block input for the looping iteration using at least the intermediate block to generate a current intermediate block output for the looping iteration (step 304).

At any looping iteration before the last looping iteration, the current intermediate block output will then be used as a current intermediate block input for the immediately subsequent looping iteration. At the last looping iteration, the current intermediate block output will then be used as the final intermediate block output.

In some implementations, two or more looping iterations share the same set of parameters of an intermediate block.

For example, having generated a current intermediate block output for a looping iteration by using an intermediate block in accordance with the set of parameters of the intermediate block, in a subsequent looping iteration, the neural network can process the current intermediate block output using the intermediate block again in accordance with the same set of parameters of the intermediate block to generate a current intermediate block output for the subsequent looping iteration, or, when then the subsequent looping iteration is the last looping iteration, process the current intermediate block output using the intermediate block again in accordance with the same set of parameters of the intermediate block to generate a final intermediate block output.

In these implementations, for each intermediate block, only one copy of the set of parameters of the intermediate block needs to be stored. That is, one or more data processing apparatuses implementing the neural network need only store a single instance of the set of parameters of each intermediate block (rather than storing multiple instances of the same set of parameters) in memory of the one or more data processing apparatuses. Then, the one copy of the set of parameters is reused across the multiple looping iterations.

In some implementations, each looping iteration uses both a common set of parameters that is the same across the two or more looping iterations, and a distinct set of adaptation parameters that is specific to the looping iteration.

That is, there are different sets of adaptation parameters that correspond respectively to different looping iterations, and the distinct set of adaptation parameters used in one looping iteration differs from the distinct set of adaptation parameters used in another looping iteration.

The common set of parameters can include more, usually orders of magnitude more, parameters than the distinct set of adaptation parameters. In practice, using a distinct set of adaptation parameters at each looping iteration can mitigate potential performance degradation caused by reduced computational capacity in a neural network that implements intermediate block looping. Because each distinct set of adaptation parameters is relatively small in size, storing these distinct sets of parameters in the memory adds minimal additional memory overhead.

At each looping iteration, the intermediate block processes, in accordance with both the common set of parameters and the distinct set of adaptation parameters that is specific to the looping iteration, a current intermediate block input for the intermediate block to generate a current intermediate block output for the intermediate block.

The system processes the final intermediate block output generated by a last intermediate block (the intermediate block with the greatest depth among the one or more intermediate blocks) using the one or more last blocks to generate the network output, or a portion or representation thereof, for the machine learning task (step 210).

For example, the system can process the final intermediate block output using the one or more last blocks to generate a particular token at a particular position within an output sequence.

As another example, the system can process the final intermediate block output using the one or more last blocks to generate an updated representation of the data item.

In particular, the system performs, using the final intermediate block output generated by the last intermediate block, a single forward pass through the one or more last blocks to generate the network output without performing any looping iterations over any of the one or more last blocks.

During each forward process, the threshold number of the looping iterations to be performed on an intermediate block can be dependent on the machine learning task. That is, the threshold number of the looping iterations performed by the system on each of the one or more intermediate blocks in the neural network during each forward pass may vary from one task to another.

In some implementations, the system determines a number of the looping iterations based on network input itself.

For example, when the network input defines a task that involves computing a composition (e.g., addition or multiplication) of n elements from a finite group, the number of the looping iterations for a single-layer intermediate block can be ┌ log2n┐.

As another example, when the network input defines a task that requires the neural network to sequentially track back or “hop” p times, the number of the looping iterations for a single-layer intermediate block can be └log2p┘+2.

As another example, when the network input defines a task that requires executing a Chain-of-Thought (CoT) reasoning process that includes m reasoning steps, the number of the looping iterations can be m (regardless of the number of layers included in each of the one or more intermediate blocks).

In some implementations, the system determines a number of the looping iterations based on the data processing apparatuses on which the neural network is deployed.

For example, this determination can be based on the memory constraints of the data processing apparatuses, e.g., the total number of layers that can be stored for each intermediate block.

In some implementations, the system obtains a target performance metric or target complexity for the machine learning task, and then determines the threshold number of the looping iterations based on the target performance metric or target complexity.

For example, the target performance metric can be received as part of or in association with the network input for the machine learning task. As another example, the target performance metric can be derived by the system from the network input, e.g., by processing an input that includes the network input using an estimation neural network.

The estimation neural network can be any of a variety of neural networks. For example, the estimation neural network can be the same as the neural network that is used to perform the task, and the input to the estimation neural network can also include an instruction to estimate the target performance metric or target complexity of the task.

More generally, the system can prompt a general-purpose large scale multi-modal language model to cause the language model to output an estimation of the target performance metric or target complexity of the task. Examples of such neural networks include those described in Comanici, Gheorghe, et al. Gemini 2.5: Pushing the frontier with advanced reasoning, multimodality, long context, and next generation agentic capabilities. arXiv preprint arXiv: 2507.06261 (2025), Gemma Team, et al. Gemma 3 Technical Report arXiv preprint arXiv: 2503.19786 (2025), and PaliGemma.

As a particular example, the system can obtain a number of layers included in each of the one or more intermediate blocks, determine an effective depth of the neural network based on the target performance metric, e.g., in accordance with a predetermined mapping between different target performance metrics (or target complexities) and different effective depths, and determine, from the number of layers included in each of the one or more intermediate blocks and the effective depth, the threshold number of the looping iterations, e.g., by dividing the effective depth by the number of layers included in each of the one or more intermediate blocks.

The effective depth of a neural network refers to the total number of layers (or, transformations applied by the layers) that input data passes through to generate a final output during a forward pass through the neural network. For example, to achieve an effective depth of 18 layers with a neural network where an intermediate block includes 9 layers, the number of the looping iterations is 2.

Iterations of the process 200 can also be performed as part of processing training inputs obtained from a set of training data in order to fine-tune the neural network with the looping mechanism on the one or more intermediate blocks in place, to determine the trained values of at least some of the parameters of the neural network, e.g., the one or more sets of adaptation parameters of each intermediate block.

In some implementations, before being fine-tuned by the above described technique, the neural network can may have been pre-trained by the system or another training system on a next token prediction task, e.g., a task that requires predicting, given a current sequence of tokens, the next token that follows the current sequence in a large unsupervised data set.

Then, the system or the other training system can fine-tune the neural network to determine the trained values of at least some of the parameters of the neural network. The system can fine-tune the neural network, with the looping mechanism on the one or more intermediate blocks in place, in any of a variety of ways.

For example, this can be done by using the large unsupervised data set and based on optimizing an unsupervised objective function appropriate for the next token prediction task, e.g., a cross-entropy loss function.

As another example, this can be done by using a set of training data specific to the task and based on optimizing an objective function, e.g., supervised loss function, appropriate for the task.

As another example, this can be done through knowledge distillation to train the neural network to, for each training input in a set of training data, process the training input to generate a training output that matches a target output generated by a teacher neural network for the same training input based on optimizing a distillation loss function.

The teacher neural network can be an already trained, non-looped neural network with a larger number of parameters. Examples of appropriate distillation loss functions include a forward Kullback-Leibler (FKL) divergence function, a reverse Kullback-Leibler (RKL) divergence function, a Jensen-Shannon divergence (JSD) function, and a total variation distance (TVD) function.

In some of these implementations, the system holds the original parameters of the neural network fixed to their pre-trained values, and only updates the values of the one or more sets of adaptation parameters of each intermediate block during the fine-tuning.

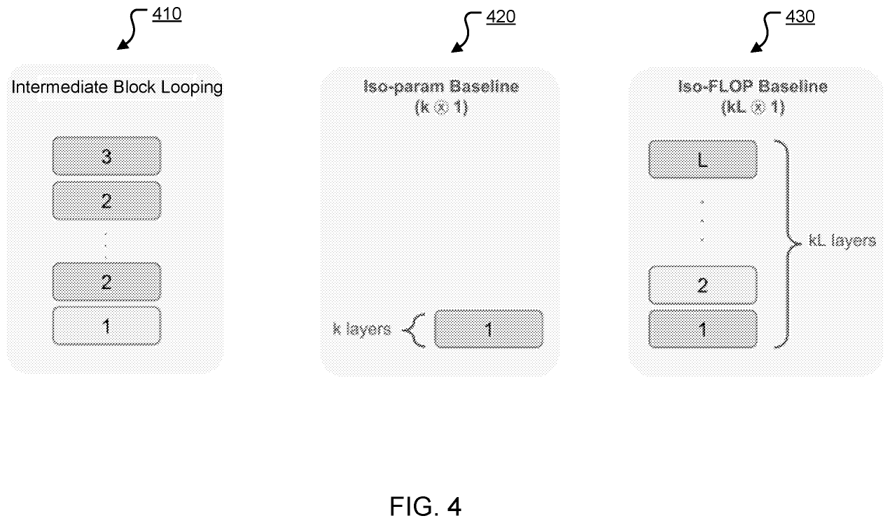

FIG. 4 is an illustration of a neural network with intermediate block looping 410 in comparison to baseline neural networks 420, 430. The neural network with intermediate block looping 410 includes a first block (block 1), an intermediate block (block 2), and a last block (block 3).

Function ƒ represents a transformation applied by the intermediate block (block 2) that includes k contiguous neural network layers in the neural network. The looping mechanism is independent of the configuration of the k contiguous neural network layers.

Thus, a final intermediate block output generated by f looped L times based on an intermediate block input, where ƒ (L)=ƒ·ƒ . . . ·ƒ, is the equivalent to a kL-layer neural network with weight sharing between all L blocks of k contiguous layers. The neural network with intermediate block looping 410 may also be referred to as (k⊗L).

The iso-param baseline neural network 420, also referred to as (k⊗1), is a k-layer neural network with the same number of distinct parameters as (k⊗L). In other words, the iso-param baseline neural network 410 is a non-looped neural network that has the exact same number of distinct parameters as the neural network with intermediate block looping 410.

The iso-FLOP baseline neural network 430, also referred to as (kL⊗1), is a kL-layer with the same effective depth as (k⊗L), but L times more parameters. In other words, the iso-FLOP baseline neural network 430 is a non-looped neural network that matches the computational cost (FLOPs) and effective depth of the neural network with intermediate block looping 410.

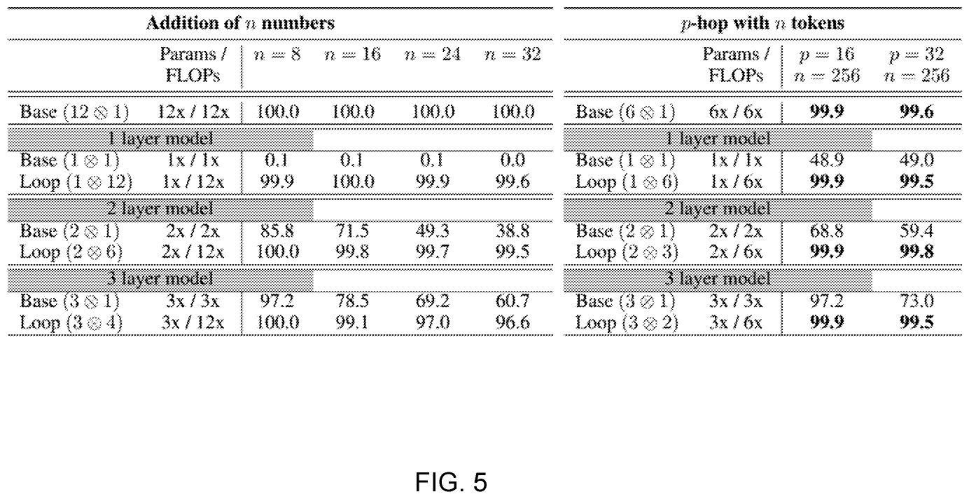

FIG. 5 shows accuracy improvements of the neural network with intermediate block looping 410 compared to the iso-param baseline neural network 420 and the iso-FLOP baseline neural network 430. The table show in FIG. 5 shows the accuracy of looped and non-looped neural networks on the n-ary addition tasks (left) and p-hop induction tasks (right).

An n-ary addition task requires a neural network to calculate the total sum of separate numbers, where the neural network operates directly on input-output text strings (e.g., Input: “315+120+045+824=”; Output=“1304”) to add randomly sampled 3-digit operands together without relying on intermediate chain-of-thought reasoning steps.

A p-hop induction task requires a neural network to recursively backtrack times to retrieve a specific answer from a sequence of characters. Given a sequence of tokens v=(v₁, . . . , vₙ) from a vocabulary, the problem is defined using a search function:
1-hop search: find₁ (v, i)=max ({0}∪{j≤i|vⱼ₋₁=vᵢ}). This finds the index of the token immediately succeeding the previous occurrence of vᵢ.
p-hop search: For p≥2, the search is applied recursively:
   findₚ (v, i)=find₁ (v, findₚ₋₁ (v, i)).

The goal of the neural network is to output the target token located at the end of this recursive chain: vfindₚ (v, n). If the p-hop sequence does not exist, the output is null.

On the left, FIG. 5 shows accuracy on n-ary addition tasks for different number of operands (n). For all budgets, a (k⊗12/k) looped neural network achieves significantly higher accuracy than the iso-param (k⊗1) neural network and nearly identical accuracy as a non-looped iso-flop (12⊗1) baseline neural network. On the right, FIG. 5 shows similar accuracy improvement on the p-hop induction tasks for different values of p. The data in this table suggests that a greater effective depth increase achieved through intermediate block looping and a small number of adaptation parameters is very effective for increasing the performance of the neural network on these tasks.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a data processing apparatus may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatuses for performing a machine learning task using a neural network that comprises a sequence of blocks, wherein the sequence of blocks comprises one or more first blocks followed by one or more intermediate blocks followed by one or more last blocks, and wherein the method comprises:
receiving a network input for a machine learning task;
processing the network input through the sequence of blocks to generate a network output for the machine learning task, the processing comprising:
for the one or more first blocks, processing the network input using the one or more first blocks to generate a first block output;
for each of the one or more intermediate blocks, processing an intermediate block input to generate a final intermediate block output, comprising repeatedly performing looping iterations until a loop termination criterion is satisfied, each looping iteration comprising:
obtaining a current intermediate block input for the looping iteration, wherein the current intermediate block input for a first looping iteration is the intermediate block input, and wherein the current intermediate block input for each subsequent looping iteration is a current intermediate block output generated by the intermediate block for a preceding looping iteration, and
processing the current intermediate block input for the looping iteration using at least the intermediate block to generate a current intermediate block output for the looping iteration; and
for the one or more last blocks, processing the final intermediate block output generated by a last intermediate block using the one or more last blocks to generate a network output for the machine learning task.

2. The method of claim 1, wherein the intermediate block input obtained for a first intermediate block is the first block output generated by the one or more first blocks from processing the network input.

3. The method of claim 2, wherein the intermediate block input obtained for each subsequent intermediate block is the final intermediate block output generated by an immediately preceding intermediate block.

4. The method of claim 1, wherein performing the machine learning task using the neural network comprises storing a single instance of each of the one or more intermediate blocks on the one or more data processing apparatuses.

5. The method of claim 1, wherein:
processing the network input using the one or more first blocks to generate the first block output comprises performing, using the network input, a single forward pass through the one or more first blocks to generate the first block output without performing any looping iterations over any of the one or more first blocks; and
processing the final intermediate block output generated by the last intermediate block using the one or more last blocks to generate the network output comprises performing, using the final intermediate block output generated by the last intermediate block, a single forward pass through the one or more last blocks to generate the network output without performing any looping iterations over any of the one or more last blocks.

6. The method of claim 1, wherein different looping iterations for a same intermediate block are associated with different sets of adaptation parameters, and wherein, at each looping iteration, processing the current intermediate block input for the looping iteration using at least the intermediate block to generate the current intermediate block output for the looping iteration comprises:
processing the current intermediate block input using (i) parameters included in the intermediate block and (ii) a respective set of adaptation parameters associated with the looping iteration to generate the current intermediate block output.

7. The method of claim 6, wherein a number of parameters included in the respective set of adaptation parameters is smaller than a number of the parameters included in the intermediate block.

8. The method of claim 6, wherein performing the machine learning task using the neural network comprises storing a single instance of each of the one or more intermediate blocks and the respective sets of adaptation parameters associated with the different looping operations for the same intermediate block on the one or more data processing apparatuses.

9. The method of claim 6, wherein the respective set of adaptation parameters comprises a respective set of low rank adaptation (LoRA) parameters of each layer included in the intermediate block.

10. The method of claim 9, wherein processing the current intermediate block input using (i) the parameters included in the intermediate block and (ii) the respective set of adaptation parameters associated with the looping iteration to generate the current intermediate block output comprises:
processing the current intermediate block input using (i) the parameters included in the intermediate block and (ii) the respective set of low rank adaptation (LoRA) parameters of each layer included in the intermediate block to generate the current intermediate block output.

11. The method of claim 1, further comprising:
receiving a target performance metric for the machine learning task; and
determining a number of the looping iterations based on the target performance metric.

12. The method of claim 11, wherein determining the number of the looping iterations based on the target performance metric comprises:
obtaining a number of layers included in each of the one or more intermediate blocks;
determining an effective depth of the neural network based on the target performance metric; and
determining, from the number of layers included in each of the one or more intermediate blocks and the effective depth, the number of the looping iterations.

13. The method of claim 1, wherein the one or more intermediate blocks each comprise a same number and type of layers.

14. The method of claim 1, wherein the neural network has a Transformer based architecture, and wherein the one or more intermediate blocks each comprise one or more attention layers.

15. The method of claim 1, wherein the machine learning task is a generative task, wherein the network input comprises a conditioning input, and wherein the network output comprises a data item.

16. The method of claim 15, wherein the data item comprises one or more of: text data, image data, video data, or audio data.

17. A system comprising:
one or more computers; and
one or more storage devices storing instructions that, when executed by the one or more computers, cause the one or more computers to perform operations for performing a machine learning task using a neural network that comprises a sequence of blocks, wherein the sequence of blocks comprises one or more first blocks followed by one or more intermediate blocks followed by one or more last blocks, and wherein the operations comprise:
receiving a network input for a machine learning task;
processing the network input through the sequence of blocks to generate a network output for the machine learning task, the processing comprising:
for the one or more first blocks, processing the network input using the one or more first blocks to generate a first block output;
for each of the one or more intermediate blocks, processing an intermediate block input to generate a final intermediate block output, comprising repeatedly performing looping iterations until a loop termination criterion is satisfied, each looping iteration comprising:
obtaining a current intermediate block input for the looping iteration, wherein the current intermediate block input for a first looping iteration is the intermediate block input, and wherein the current intermediate block input for each subsequent looping iteration is a current intermediate block output generated by the intermediate block for a preceding looping iteration, and
processing the current intermediate block input for the looping iteration using at least the intermediate block to generate a current intermediate block output for the looping iteration; and
for the one or more last blocks, processing the final intermediate block output generated by a last intermediate block using the one or more last blocks to generate a network output for the machine learning task.

18. The system of claim 17, wherein the neural network has a Transformer based architecture, and wherein the one or more intermediate blocks each comprise one or more attention layers.

19. The system of claim 17, wherein the machine learning task is a generative task, wherein the network input comprises a conditioning input, and wherein the network output comprises a data item.

20. One or more non-transitory computer-readable storage media storing instructions that when executed by one or more computers cause the one or more computers to perform operations for performing a machine learning task using a neural network that comprises a sequence of blocks, wherein the sequence of blocks comprises one or more first blocks followed by one or more intermediate blocks followed by one or more last blocks, and wherein the operations comprise:
receiving a network input for a machine learning task;
processing the network input through the sequence of blocks to generate a network output for the machine learning task, the processing comprising:
for the one or more first blocks, processing the network input using the one or more first blocks to generate a first block output;
for each of the one or more intermediate blocks, processing an intermediate block input to generate a final intermediate block output, comprising repeatedly performing looping iterations until a loop termination criterion is satisfied, each looping iteration comprising:
obtaining a current intermediate block input for the looping iteration, wherein the current intermediate block input for a first looping iteration is the intermediate block input, and wherein the current intermediate block input for each subsequent looping iteration is a current intermediate block output generated by the intermediate block for a preceding looping iteration, and
processing the current intermediate block input for the looping iteration using at least the intermediate block to generate a current intermediate block output for the looping iteration; and
for the one or more last blocks, processing the final intermediate block output generated by a last intermediate block using the one or more last blocks to generate a network output for the machine learning task.
